(19) United States
(12) Patent Application Publication
(10) Pub. No.: US 2005/0225167 A1
(43) Pub. Date: Oct. 13, 2005

(54) Master brake cylinder unit for an electrohydraulic vehicle brake system

(76) Inventor: Michael Kunz, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/513,110

(22) PCT Filed: Jul. 15, 2003
(86) PCT No.: PCT/DE03/02368

§ 371 Date: Nov. 1, 2004

(30) Foreign Application Priority Data
Jul. 25, 2002 (DE) 102 33 838.8

(51) Int. Cl. B60T 8/42

(52) U.S. Cl. 303/115.1

(57) ABSTRACT

The invention relates to a master cylinder unit for an electrohydraulic vehicle brake system in which the master cylinder unit includes with a first piston which is located in a second piston and which slaves the second piston after displacement by a predetermined piston travel. Upon braking actuated by external force, a pressure, as a set-point value for the electrohydraulic vehicle brake system, is built up solely with the first piston while for braking using muscle force, if the electrohydraulic vehicle brake system fails, the piston area of both pistons together is available.

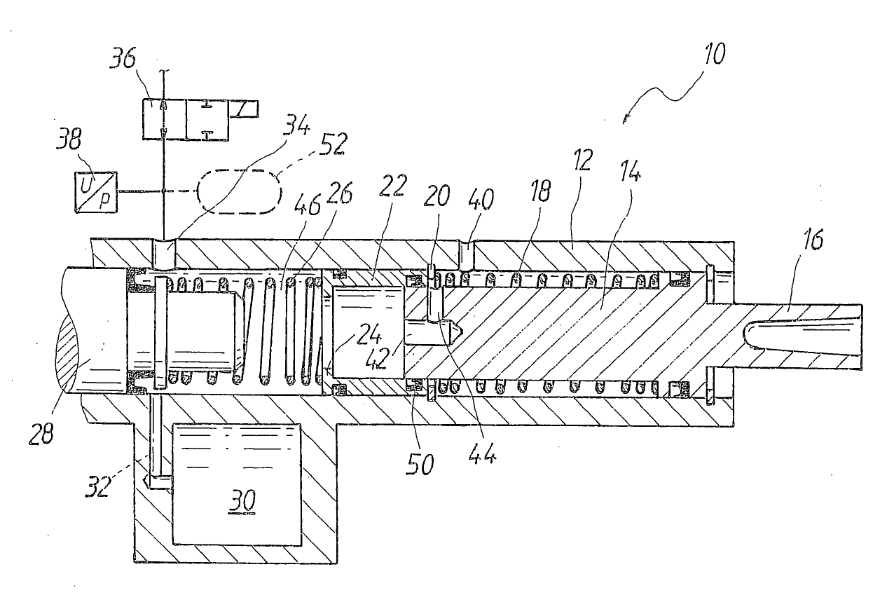

### BACKGROUND OF THE INVENTION

The invention relates to a master cylinder unit for an electrohydraulic vehicle brake system, having the characteristics of the preamble to claim 1.

Electrohydraulic vehicle brake systems are known. They are so-called external force brake systems, in which the energy required for braking originates in a hydraulic pump that is driven by an electric motor. Typically, the hydraulic pump pumps brake fluid into a hydraulic reservoir, to which wheel brake cylinders are connected with the interposition of magnet valves. The interposition of a hydraulic reservoir for storing brake fluid under pressure has the advantage that the hydraulic pump need not be constantly in operation, and nevertheless brake fluid under pressure is available at any time for braking. With the magnet valves, the wheel brake pressure in the wheel brake cylinders is regulated.

The wheel brake pressure in the wheel brake cylinders is regulated as a function of a set-point value, which is specified by a driver with a brake pedal, a hand brake lever, or in some other way.

As the set-point value transducer, a master cylinder unit with a first piston displaceable in a cylinder is often used, of the kind known for hydraulic vehicle brake systems actuated by muscle force. For embodiment as a dual-circuit or tandem master cylinder unit, it may also have a further piston. The electrohydraulic vehicle brake system is connected to the master cylinder unit with the interposition of a disconnection valve for each brake circuit. For braking, by closure of the disconnection valves, the master cylinder unit is disconnected hydraulically from the rest of the vehicle brake system, and the vehicle brake system is actuated by external force. Either the pressure generated in the master cylinder unit by depressing a brake pedal or pulling a hand brake lever, or the force with which the brake pedal is depressed or the hand brake lever is pulled, or the distance by which the brake pedal or the hand brake lever is moved, is used as the set-point value for the wheel brake pressure in the wheel brake cylinders. The energy required for braking is accordingly generated with the hydraulic pump, and not with the master cylinder unit. In the event of a failure of the hydraulic pump, the electrohydraulic vehicle brake system can be actuated like a muscle force brake system, with the master cylinder unit; in that case, the disconnection valves remain open. Using a master cylinder unit as a set-point value transducer for an electrohydraulic vehicle brake system has the goal of enabling actuation of the vehicle brake system by muscle force in the event of hydraulic pump failure.

Since for external-force braking the disconnection valves are closed, no brake fluid can be positively displaced out of the cylinder of the master cylinder unit, and consequently the first piston cannot be displaced, or can be displaced only slightly; moreover, the brake pedal or other actuating means can be depressed even with great force by only a fraction of the usual distance.

To simulate the customary dependency of the pedal travel on the pedal force, so-called pedal travel simulators are known. These are a hydraulic reservoir that is connected to the master cylinder unit and into which brake fluid from the master cylinder unit can be positively displaced. The hydraulic reservoir can be connected to the master cylinder unit via a blocking valve that is closed when without current and that is opened for external-force braking. Such a blocking valve prevents brake fluid from being positively displaced out of the master cylinder unit into the hydraulic reservoir in a muscle-force braking event. Such a blocking valve is not absolutely necessary and is therefore not provided in every case.

### SUMMARY AND ADVANTAGES OF THE INVENTION

The master cylinder unit of the invention, having the characteristics of claim 1, has besides the first piston a second piston and a slaving device, which after displacement of the first piston by a predetermined piston travel distance slaves the second piston to the first piston. The piston area of the first and second pistons together that is effective for positive displacement of brake fluid out of the cylinder is greater than a piston area of the first piston alone that is effective for positive displacement of brake fluid out of the cylinder. Accordingly, upon displacement of the first and second piston in common by a defined distance, a greater volume of brake fluid is positively displaced from the master cylinder unit than upon displacement of only the first piston by the same distance. The second piston of the master cylinder unit of the invention must not be mistaken for a further piston of a conventional dual-circuit or tandem master cylinder unit for a dual-circuit vehicle brake system; the second piston of the master cylinder unit of the invention may already be present anyway, in addition to such a further piston. Unlike a further piston of a dual-circuit or tandem master cylinder unit, which acts upon a brake circuit that is independent of the first piston, the second piston of the master cylinder unit of the invention acts upon the same brake circuit as the first piston. The first piston of the master cylinder unit of the invention has the purpose of increasing the volume of brake fluid positively displaced per piston travel, if the first piston has been displaced by more than the predetermined piston travel. The predetermined piston travel along which the first piston is displaced without the second piston in the cylinder is intended for external force actuation of the electrohydraulic vehicle brake system, in which the master cylinder unit is hydraulically disconnected from the rest of the vehicle brake system by closure of the disconnection valve or valves and serves solely as a set-point value transducer for the brake force. Since the first piston alone positively displaces less brake fluid per piston travel than the first and second pistons together, the invention makes a smaller hydraulic reservoir possible as the pedal travel simulator. Another advantage of the invention is a faster pressure buildup by the first piston and accordingly improved recognition of the driver's wishes in terms of braking. Even a possible inclusion of air in the master cylinder unit is improved by way of the dependency of the master cylinder pressure on the piston travel.

The second piston, which after the predetermined piston travel has been overcome is slaved to the first piston, increases the volume of brake fluid positively displaced per piston travel and as a result assures an adequate volume of brake fluid upon muscle force actuation of the electrohydraulic vehicle brake system if the hydraulic pump fails.

Features and refinements of the invention defined by claim 1 are the subject of the dependent claims.

### DRAWING

The invention will be described in further detail below in terms of an exemplary embodiment shown in the drawing. The sole drawing FIGURE shows a master cylinder unit of the invention in axial section.

### DESCRIPTION OF THE EXEMPLARY EMBODIMENT

The master cylinder unit 10 of the invention, shown in the drawing, is intended for an electrohydraulic vehicle brake system, not otherwise shown. The master cylinder unit 10 has a cylinder 12 and a first piston 14, which is displaceable in the cylinder 12. The displacement of the first piston 14 is effected in a manner known per se via a plunger rod 16, for instance by means of a brake pedal, not shown, or a hand brake lever, not shown. A brake booster, in particular an underpressure brake booster (not shown) may be connected to the cylinder 12 in a manner known per se. Such a brake booster does not affect the function of the master cylinder unit 10.

An outside diameter of the first piston 14 is less than an inside diameter of the cylinder 12; an annular interstice exists between the first piston 14 and the cylinder 12, and the first piston 14 is disposed coaxially in the cylinder 12. A first spring element 18 in the form of a helical compression spring is braced on a securing ring 20 inserted into the cylinder 12 and presses both the first piston 14 and the plunger rod 16 into an outset position.

A second piston 22 is placed on the first piston 14; it is tubular and fills the interstice between the first piston 14 and the cylinder 12. The second piston 22 provides sealing between the cylinder 12 and the first piston 14. The second piston 22 has an inward-protruding flange on its side remote from the plunger rod 16, which fits over an end face, remote from the plunger rod 16, of the first piston 14. In its outset position shown in the drawing, the flange has an axial spacing from the first piston 14. If upon actuation of the master cylinder unit 10 the first piston 14 is displaced, it first moves by a predetermined piston travel, which is equivalent to the axial spacing from the flange of the second piston 22, by itself, without the second piston 22. After this predetermined piston travel has been overcome, the first piston 14 meets the inward-protruding flange of the second piston 22 and as a result, upon further displacement of the first piston 14, moves the second piston 22 with the first piston 14. The inward-protruding flange of the second piston 22 forms a stop or a slaving device 24, which after the predetermined piston travel has been overcome by the first piston 14 slaves the second piston 22 to this first piston.

In its outset position, the second piston 22 rests on the securing ring 20 inserted into the cylinder 12. A second spring element 26, embodied as a helical compression spring, moves the second piston 22 into its outset position. The second spring element 26 is disposed in the cylinder 12 between the second piston 22 and a further piston 28. The further piston 28, of which only a fraction oriented toward the first and second pistons 14, 22 is shown in the drawing, is a so-called floating piston, of the kind that is usual in and known from conventional master cylinders of hydraulic vehicle brake systems. The further piston 28 embodied as a floating piston hydraulically disconnects two brake circuits of the electrohydraulic vehicle brake system, not shown, from one another. This is known per se and will not be described in further detail here. Because of the provision of the further piston 28, the master cylinder unit 10 is embodied as a dual-circuit or tandem master cylinder unit 10.

A hydraulic reservoir is disposed on an outside of the cylinder 12 and forms a pedal travel simulator 30. The pedal travel simulator 30 communicates through a bore 32 with the cylinder 12. Since the volume of the pedal travel simulator 30, because of the small effective surface area of the first piston 14, can be kept small, it is possible to dispense with a blocking device that disconnects the pedal travel simulator 30 hydraulically from the master cylinder unit 10 upon a displacement of the second piston. The pedal travel simulator may also be embodied separately from the cylinder 12. Instead of the pedal travel simulator 30, for instance, a separate hydraulic reservoir 52 represented by dashed lines in the drawing may be connected as a pedal travel simulator to the pressure connection 34 of the cylinder 12.

The electrohydraulic vehicle brake system, not otherwise shown, is connected to a pressure connection 34 of the cylinder 12 in a manner known per se via a disconnection valve 36. The disconnection valve 36 is a 2/2-way magnet valve that is open in its basic position when it is without current. A pressure sensor 38 is also connected to the pressure connection 34 of the cylinder 12.

Through a refill bore 40, the cylinder 12 is connected to a brake fluid container, not shown. The refill bore 40 discharges into the interstice between the first piston 14 and the cylinder 12. Through an axial blind bore 42 and a transverse bore 44, discharging into it, in the first piston 14, the refill bore 40 and thus the brake fluid container, not shown, communicate with a pressure chamber 46 of the cylinder 12, on a side of the first and second pistons 14, 22 that is remote from the plunger rod 16. The second spring element 26, which presses the second piston 22 into its outset position, is disposed in the pressure chamber 46. The transverse bore 44 is made in the first piston 14 in such a way that after a short displacement distance, or travel, of the first piston 14, it overtakes a seal 50 of the second piston 22 and is closed as a result. The brake fluid container, not shown, is as a result disconnected hydraulically from the pressure chamber 46 after a short displacement distance of the first piston 14.

The function of the master cylinder unit 10 of the invention is as follows: For actuation of the electrohydraulic brake system, not shown, the plunger rod 16 and with it the first piston 14 are displaced, for instance by means of a brake pedal, not shown. At the onset of the displacement, the disconnection valve 36 is closed, and as a result the electrohydraulic vehicle brake system, not shown, is disconnected hydraulically from the cylinder 12. The pressure generated in the pressure chamber 46 by displacement of the first piston 14 is measured by the pressure sensor 38; this sensor forms a set-point value for a wheel brake pressure to be built up in wheel brake cylinders by the electrohydraulic vehicle brake system. The wheel brake pressure is built up by an electrically driven hydraulic pump, not shown, and is regulated with magnet valves. This is known per se and will not be described further here. The master cylinder unit 10 acts as a set-point value transducer for the wheel brake pressure to be built up with the electrohydraulic vehicle brake system; the wheel brake pressure is not built up with the master cylinder unit 10; instead, this master cylinder unit is disconnected hydraulically from the electrohydraulic vehicle brake system by the closed disconnection valve 36.

Upon displacement, the first piston 14 positively displaces brake fluid from the pressure chamber 46 of the cylinder 12 into the pedal travel simulator 30. Positive displacement of brake fluid from the pressure chamber 46 with the disconnection valve 36 closed is possible because of the elasticity of the cylinder 12 and the compressibility of the brake fluid. If the elasticity and compressibility are inadequate, then the pedal travel simulator 30 may for instance be embodied with a diaphragm acted upon by gas pressure or with a piston (not shown) acted upon by a spring; these provisions are known per se. Since an effective surface area of the first piston 14 upon positive displacement of brake fluid is small because of the small diameter of this piston, at even slight axial force the first piston 14 builds up a high pressure. As a result, virtually the same dependency as usual between axial force and displacement distance of the first piston 14 as in conventional master cylinder units, and thus virtually the same pedal feel as usual when the brake pedal is depressed, are thus attained.

For detecting air bubbles in the cylinder 12 as well, the small diameter of the first piston 14 and the resultant high pressure buildup at comparatively slight axial force on the first piston 14 are advantageous, since a higher pressure level can be better measured with the pressure sensor 38. An air inclusion in the cylinder 12 can be ascertained by measuring the pressure buildup in the positive-displacement chamber 46 and a displacement distance of the first piston 14. If for a defined displacement distance of the first piston 14, the pressure buildup in the pressure chamber 46 is less than usual, this is an indication of an air inclusion in the cylinder 12; the air inclusion 46 may be either in the pressure chamber 46 shown for the first brake circuit or in the pedal travel simulator 30 or in the pressure chamber, not shown in the drawing, of the second brake circuit.

Because of the small diameter of the first piston 14 and hence the small piston area effective upon positive displacement of brake fluid, the brake fluid volume positively displaced by the first piston 14 is slight, and consequently a small pedal travel simulator 30 suffices. This reduces the structural size.

If the electrohydraulic vehicle brake system fails, the disconnection valve 36 is not closed upon actuation of the master cylinder unit 10 of the invention. Upon actuation, the first piston 14 is initially displaced far enough that it meets the inward-protruding flange of the second piston 22 that forms the slaving device 24. Upon further displacement of the first piston 14, this piston moves together with the second piston 22, by way of the slaving device 24. The effective piston area is as a result increased to the sum of the piston areas of both pistons 14, 22 and thus to an internal cross-sectional area of the cylinder 12. Because the first and second pistons 14, 22 are displaced jointly, a correspondingly greater volume of brake fluid per piston travel is accordingly positively displaced out of the cylinder 12. As a result, actuation of the electrohydraulic vehicle brake system by muscle force, in the manner known from hydraulic vehicle brake systems, is possible. The muscle force can be boosted by a brake booster, known per se and not shown, in particular an underpressure brake booster.

1-5. (canceled)

6. A master cylinder unit (10) for an electrohydraulic vehicle brake system, comprising
a first piston (14) displaceable in a cylinder (12),
a pedal travel simulator that communicates with the cylinder, and
a second piston (22) and a slaving device (24) in the cylinder (12), which after displacement of the first piston (14) by a predetermined piston travel slaves the second piston (22) to the first piston (14);
the piston area, effective for positive displacement of brake fluid out of the cylinder (12), of the two pistons (14, 22) together being greater than a piston area, effective for positive displacement of brake fluid out of the cylinder (12), of the first piston (14).

7. The master cylinder unit of claim 6, wherein the first piston (14) is located inside the second piston (22).

8. The master cylinder unit of claim 6, wherein the slaving device (24) has a stop, which after displacement of the first piston (14) by the displacement distance slaves the second piston (22) to the first piston (14).

9. The master cylinder unit of claim 6, wherein when the master cylinder unit (10) is not actuated, the cylinder (12) communicates with a brake fluid container; and wherein the brake fluid container is disconnected from the cylinder (12) by a short displacement of the first piston (14).

10. The master cylinder unit of claim 6, wherein the master cylinder unit (10) is embodied as a tandem master cylinder unit (10) for a dual-circuit vehicle brake system.
